(19) United States
(12) Patent Application Publication
(10) Pub. No.: US 2024/0166974 A1
(43) Pub. Date: May 23, 2024

(54) Detergent Preparation Having Improved Properties

(71) Applicant: Henkel AG & Co. KGaA, Duesseldorf (DE)

(72) Inventors: Inga Kerstin Vockenroth, Duesseldorf (DE); Piotr Tkacz, Monheim am Rhein (DE); Arno Dueffels, Duesseldorf (DE)

(73) Assignee: Henkel AG & Co. KGaA, Duesseldorf (DE)

(21) Appl. No.: 18/504,757

(22) Filed: Nov. 8, 2023

(30) Foreign Application Priority Data
Nov. 9, 2022 (DE) 102022211873.1

(51) Int. Cl. C11D 3/386; C11D 3/30; C11D 11/00; C11D 17/04

(52) U.S. Cl. CPC C11D 3/38636; C11D 3/30; C11D 11/0017; C11D 17/042; C12Y 302/01052

(57) ABSTRACT

The present invention relates to a detergent preparation containing, relative to the total weight thereof, a hexosaminidase preparation and 0.5 to 10 wt % of a polyalkoxylated amine having a weight-average molecular weight M_{w} in the range of 600 g/mol to 10,000 g/mol, which is obtainable by reacting ammonia or primary alkyl or hydroxyalkylamines having a molecular weight of less than 200 g/mol with alkylene oxides; and textile washing methods using this detergent preparation.

### FIELD OF THE INVENTION

The application relates to an enzyme and amine-containing detergent preparation. Furthermore, the application relates to a method for washing textiles using the detergent preparation.

### BACKGROUND OF THE INVENTION

Continuously changing requirements are placed on the forms of manufacture and supply of washing and cleaning agents. The main focus has, for quite some time, been on the convenient dosing of washing agents and cleaning agents by the consumer and the simplification of the work steps necessary for carrying out a washing or cleaning method. A technical solution is provided by pre-portioned detergents or cleaning agents—for example, film pouches having one or more receiving chambers for solid or liquid detergents or cleaning agents.

A trend relevant to the production of these film pouches is the miniaturization of these film pouches. In addition to higher consumer acceptance due to simplified handling, the background of this development is, in particular, sustainability aspects, for example in relation to transport volumes and costs and the quantity of packaging materials used.

The concentrating of modern detergents presupposes a progressive optimization of existing detergent formulations and the development of new, more efficient detergent formulations. One aim of these developments, in which generally known active washing or cleaning ingredients are used, is to achieve an increase in the washing power of the detergent formulations with a constant or reduced dosing quantity. With regard to bleachable impurities, the use of bleaching agents should preferably be dispensed with for reasons of sustainability. The group of known active washing or cleaning ingredients includes, for example, the hexosaminidases and the surfactant-active alkoxylated alkanolamines.

Hexosaminidase-containing fabric detergents are described, for example, in the international patent application WO 2019/086520 A1.

European application EP 3 617 299 A1 describes active washing or cleaning ingredients from the group of amino-based alkoxylates.

### BRIEF DESCRIPTION OF THE INVENTION

The invention was based upon the object of providing high-performance detergent preparations which can be produced easily and efficiently, have good storability and a good primary and secondary washing effect, and in particular a good cleaning effect on bleachable stains, and can preferably be packaged in concentrated form in water-soluble film pouches.

### DETAILED DESCRIPTION OF THE INVENTION

A first subject matter of the application is a detergent preparation containing, relative to the total weight thereof,
a) hexosaminidase preparation;
b) 0.5 to 10 wt % of a polyalkoxylated amine having a weight-average molecular weight M_{w} in the range of 600 g/mol to 10,000 g/mol, which is obtainable by reacting ammonia or primary alkyl or hydroxyalkylamines having a molecular weight of less than 200 g/mol with alkylene oxides.

The detergent preparation is preferably flowable under standard conditions (20° C., 1,013 mbar).

Surprisingly, the combination of a hexosaminidase and specific amounts of a specific polyalkoxylated polyalkylene amine has a synergistic effect with respect to the cleaning of textile surfaces, and in particular with respect to the cleaning of cotton textiles.

As a first optional component, the detergent preparations contain a hexosaminidase preparation.

The term, “hexosaminidase,” denotes a polypeptide with hexosaminidase activity (hexosaminidases) and includes enzymes which catalyze the hydrolysis of N-acetyl-D-hexosamine—or N-acetylglucosamine polymers.

Polypeptides with hexosaminidase activity include dispersins, such as Dispersin B (DspB), which are β-N-acetylglucosamininidases belonging to the glycoside hydrolase 20 family. Dispersins are produced by the parodontal pathogen Aggregatibacter actinomycetemcomitans, a gram-negative oral bacterium. Dispersin B is a β-hexosaminidase, which specifically hydrolyzes β-1,6-glycosidic bonds of acetylglucosamine polymers. The use of hexosaminidases from the group of β-hexosaminidases is preferred.

With respect to the cleaning performance, particularly advantageous detergent preparations contain, relative to the total weight thereof, 0.01 to 5 wt %, preferably 0.1 to 4 wt %, and in particular 0.15 to 2.5 wt %, hexosaminidase preparation.

In addition to the above-described hexosaminidase preparation, the detergent preparation can contain one or more further enzyme preparations. Due to their improved cleaning effect, detergent preparations are preferred which, in relation to the total weight thereof, contain 0.2 to 8 wt %, and preferably 0.5 to 6 wt %, enzyme preparation.

In addition to the actual enzyme protein, an enzyme preparation comprises further components such as enzyme stabilizers, carrier materials or fillers. In this case, the enzyme protein typically forms only a fraction of the total weight of the enzyme preparation. Enzyme preparations which are preferably used contain between 0.1 and 40 wt %, preferably between 0.2 and 30 wt %, more preferably between 0.4 and 20 wt %, and most preferably between 0.8 and 10 wt % of the enzyme protein. In such compositions, an enzyme stabilizer can be contained in an amount of 0.05 to 35 wt %, and preferably 0.05 to 10 wt %, relative to the total weight in the enzyme composition.

The protein concentration can be determined using known methods, for example the BCA method (bicinchoninic acid; 2,2′-bichinolyl-4,4′-dicarboxylic acid) or the Biuret method. The active protein concentration is determined in this regard via titration of the active centers using a suitable irreversible inhibitor (for proteases, for example, phenylmethylsulfonylfluoride (PMSF)), and determination of the residual activity.

It is preferred if the detergent preparation contains at least one enzyme preparation, preferably at least 3 enzyme preparations of enzymes from the group of lipase, amylase, protease, cellulase, preparations of a pectinolytic enzyme and endoglucanase.

According to the invention, it is preferred if the detergent preparation contains at least one lipase preparation. Lipases preferred according to the invention are selected from at least one enzyme of the group formed from triacylglycerol lipase (E.C. 3.1.1.3), and lipoprotein lipase (E.C. 3.1.1.34) and monoglyceride lipase (E.C. 3.1.1.23).

Preferred lipase preparations according to the invention are the commercial products marketed by Amano Pharmaceuticals under the names Lipase M-AP10e, Lipase LE® and Lipase F® (also Lipase JV®). For example, Lipase F® is naturally present in Rhizopus oryzae. Lipase M-AP10e, for example, is naturally present in Mucor javanicus.

A highly preferred lipase is commercially available from Novozymes (Denmark) under the trade name, Lipex®, and can advantageously be used in the detergent preparations according to the invention. The Lipase Lipex® 100 L is particularly preferred here.

Preferred detergent preparations are characterized in that they contain, relative to the total weight thereof, 0.01 to 1 wt %, and in particular 0.05 to 0.3 wt %, lipase preparation.

The detergent preparations preferably contain at least one amylase, and in particular α-amylase, α-amylases (E.C. 3.2.1.1) hydrolyze α-1,4-glycosidic bonds of starch and starch-like polymers as internal enzymes. As an example, α-amylases from Bacillus licheniformis, from B. amyloliquefaciens, and from B. stearothermophilus, as well as the refinements thereof that have been improved for use in washing or cleaning agents, may be mentioned. The enzyme from B. licheniformis is available from Novozymes under the trade name Termamyl® and from Genencor under the trade name Purastar® ST. Development products of these α-amylases are available from Novozymes under the trade names, Duramyl® and Termamyl® ultra, from Genencor under the name, Purastar® OxAm, and from Daiwa Seiko Inc., Tokyo, Japan, as Keistase®. The α-amylase from B. amyloliquefaciens is marketed by Novozymes under the name, BAN®, and derived variants from the α-amylase from B. stearothermophilus are marketed under the names, BSG® and Novamyl®, also from Novozymes. Examples of α-amylases from other organisms are the refinements of α-amylase from Aspergillus niger and A. oryzae that are available under the trade name, Fungamyl®, from Novozymes.

The proportion by weight of the amylase preparation, and in particular the amylase preparation, with respect to the total weight of the detergent preparation is preferably 0.1 to 2 wt %, and in particular 0.2 to 1 wt %.

It is preferred according to the invention if at least one protease is contained in the detergent preparation as the enzyme. A protease is an enzyme that cleaves peptide bonds by hydrolysis. Each of the enzymes from class E.C. 3.4 according to the invention falls thereunder (comprising each of the thirteen subclasses which fall thereunder). According to the invention, “protease activity” is present if the enzyme has proteolytic activity (EC 3.4). Different types of protease-activity are known. The three main types are: trypsin-like, where the amide substrate is cleaved following the amino acids Arg or Lys at P1; chymotrypsin-like, where cleavage takes place following one of the hydrophobic amino acids at P1; and elastase-like, where the amide substrate is cleaved following Ala at P1.

Surprisingly, it was found that a protease of the type of alkaline protease from Bacillus lentus DSM 5483 or a protease sufficiently similar to this (based upon the sequence identity), which has several of these changes in combination, is particularly suitable for use in the liquid detergent preparation according to the invention and advantageously stabilizes in an improved manner therein. Advantages of using this protease thus arise in particular with regard to washing performance and/or stability.

Very particularly preferably, the detergent preparation according to the invention contains protease of the alkaline protease type from Bacillus lentus DSM 5483 or a protease which is sufficiently similar to this (based upon the sequence identity) and has several of these modifications in combination.

The proportion by weight of the protease preparation with respect to the total weight of the detergent preparation is preferably 0.2 to 3 wt %, and in particular 0.4 to 2 wt %.

Preferred detergent preparations contain as an optional component, relative to the total weight thereof, 0.05 to 2 wt %, and preferably 0.1 to 0.4 wt %, of a preparation of a pectinolytic enzyme.

In the context of the present invention, the pectinolytic enzymes include enzymes having the names pectinase, pectate lyase, pectin esterase, pectin demethoxylase, pectin methoxylase, pectin methylesterase, pectase, pectin methylesterase, pectinesterase, pectin pectyl hydrolase, pectin depolymerase, endopolygalacturonase, pectolase, pectin hydrolase, pectin polygalacturonase, 20 endopolygalacturonase, poly-α-1,4-galacturonide, glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase, or 25 exopolygalacturanosidase. The use of pectin lyases is very particularly preferred here.

Within the EC classification of enzymes—the numerical classification system for enzymes—the pectinolytic enzymes belong in particular to the enzyme classes (“Enzyme Commission number”) EC 3.1.1.11, EC 3.2.1.15, EC 3.2.1.67, and EC 3.2.1.82 and consequently belong to the third of the six main enzyme classes, the 10 hydrolases (E.C.3. hereunder to the glycosylases (E.C. 3.2.-.-) and in turn hereunder to the glycosidases (E.C. 3.2.1.-), i.e., enzymes which hydrolyze O—and/or S-glycosyl compounds. Consequently, pectinolytic enzymes act in particular against residues on dishes which contain pectic acid and/or other galacturonans, and catalyze the hydrolysis thereof.

In the context of the invention, pectate lyases are enzymes which catalyze the non-hydrolytic cleavage of pectate according to an endo mechanism.

Examples of suitable pectinolytic enzymes are the enzymes and enzyme preparations available under the trade names Gamanase®, Pektinex AR®, X-Pect® or Pectaway® from Novozymes, under the trade names Rohapect UF®, Rohapect TPL®, Rohapect PTE100®, Rohapect MPE®, 30 Rohapect MA plus HC, Rohapect DA12L®, Rohapect 10L®, Rohapect B1 L® from AB Enzymes, and under the trade name Pyrolase® from Diversa Corp., San Diego, CA, USA.

As a preferred component, the detergent preparation contains 0.01 to 1 wt. %, preferably 0.02 to 0.3 wt. %, of a mannanase preparation.

A mannanase catalyzes the hydrolysis of 1,4-beta-D-mannosidic bonds in mannans, galactomannans, glucomannans and galactoglucomannans. Said mannanases are classified according to the enzyme nomenclature as E.C. 3.2.1.78.

As a further preferred optional component, the detergent preparations contain a cellulase preparation. Synonymous terms can be used for cellulases, in particular endoglucanase, endo-1,4-beta-glucanase, carboxymethyl cellulase, endo-1,4-beta-D-glucanase, beta-1,4-glucanase, beta-1,4-endoglucanhydrolase, celludextrinase or avicelase. Within the meaning of the invention, whether or not an enzyme is a cellulase is decided by its ability to hydrolyze 1,4-β-D-glucosidic bonds in cellulose.

Cellulases (endoglucanases, EG) suitable according to the invention include, for example, fungal compositions rich in endoglucanase (EG), which are provided by the company Novozymes under the trade name Celluzyme®. The products Endolase® and Carezyme®, also available from Novozymes, are based on 50 kD-EG and 43 kD-EG, respectively, from Humicola insolens DSM 1800. Further commercial products from this company that can be used are Cellusoft®, Renozyme®, and Celluclean®. It is also possible to use cellulases, for example, which are available from AB Enzymes, Finland, under the trade names Ecostone® and Biotouch®, and which are, at least in part, based on 20 kD-EG from Melanocarpus. Further cellulases from AB Enzymes are Econase® and Ecopulp®. Further suitable cellulases are from Bacillus sp. CBS 670.93 and CBS 669.93, wherein the cellulase from Bacillus sp. CBS 670.93 is available from Danisco/Genencor under the trade name, Puradax®. Other commercial products from Danisco/Genencor that can be used are “Genencor detergent cellulase L” and IndiAgeeNeutra.

The proportion by weight of the cellulase preparation with respect to the total weight of the detergent preparation is preferably 0.01 to 1 wt %, and in particular 0.05 to 0.3 wt %.

As a further optional component, the detergent preparation contains, in addition to the hexosaminidase preparation, a specific polyalkoxylated amine having a proportion by weight of 0.5 to 10 wt %. Preferred detergent preparations contain, relative to the total weight thereof, 1 to 9 wt %, and preferably 1.5 to 7.5 wt %, polyalkoxylated amine. Corresponding weight portions have proven advantageous for the storage life, but in particular for the cleaning performance.

Preferred polyalkoxylated amines have a weight-average molecular weight M_{w} in the range from 1300 g/mol to 6000 g/mol, in particular from 1400 g/mol to 4500 g/mol. (The average molecular weights indicated here, and later optionally for other polymers, are weight-average molecular weights M_{w} which can in principle be determined by means of gel permeation chromatography with the aid of an RI detector, wherein the measurement is expediently carried out against an external standard.) For their preparation, it is possible to start, in a known manner, from ammonia, a monoalkylamine, a monoalkylaminoamine or a monoalkyl-dialkanolamine or a mono-, di-, or trialkanolamine, e.g., triethanolamine, methyl-, ethyl-, propyl-, and isopropyl-diethanolamine, methyl-, ethyl-, propyl-, and isopropyl-diisopropanolamine, tripropanolamine, triisopropanolamine, N,N-Di-(2-hydroxyethyl)cyclohexylamine, N,N-Di-(2-hydroxypropyl)cyclohexylamine, n-butylamine, n-hexylamine, n-octylamine, isopropylamine, sec-butylamine, tert-butylamine, cyclohexylamine, 2-ethylhexylamine, 2-phenylethylamine, and mixtures thereof, which is reacted with an alkylene oxide—in particular, selected from the group consisting of ethylene oxide, propylene oxide, butylene oxide, and mixtures thereof, in particular with a mixture containing propylene oxide and preferably ethylene oxide, and particularly preferably with propylene oxide. The polyalkoxylated amines thus obtainable may be block or random structures. Particular preference is given, inter alia, to a polyalkoxylated amine obtainable by propoxylation of triethanolamine, and preferably having a length of the three side arms of 15 propylene oxide units in each case. Also preferred is a polyalkoxylated amine obtainable by propoxylation of triisopropanolamine, and preferably having a length of the three side arms of 15 propylene oxide units in each case. Polyalkoxylated monoalkylamines having a linear, branched or cyclic alkyl group are likewise suitable, an alkylene oxide selected from the group consisting of ethylene oxide, propylene oxide, butylene oxide, and mixtures thereof being alkoxylated—preferably with a mixture comprising propylene oxide, and more preferably with propylene oxide. Preference is also given to a polyalkoxylated amine obtainable by propoxylation of tert-butylamine, and preferably having a length of the two side arms of 12 propylene oxide units in each case.

Preferred polyalkoxylated amines satisfy the general formula (I),

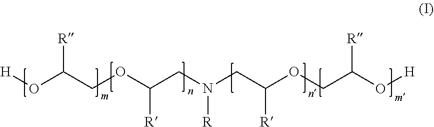

in which R represents a linear, optionally branched or optionally cyclic alkyl group having 1 to 12 C atoms or a —(CH₂CHR′O)ₙ—(CH₂CHR″O)ₘ—H group,
R′ and R″, independently of one another, represent H, CH₃ or CH₂CH₃,
n, n′, and n″, independently of one another, represent numbers from 0 to 30, preferably from 0 to 10, and in particular 0 to 5, and
m, m′, and m″, independently of one another, represent numbers from 0 to 30, preferably from 5 to 20, and in particular from 12 to 16.
with the proviso that the sum n+n′+n″+m+m′+m″ is at least 14, preferably in the range of from 18 to 100 and in particular in the range of from 20 to 70. Preferably, in the compounds of the formula I, at least one of the functional groups R′ and R″ is a CH₃ group.

Preferred detergent preparations contain, relative to the total weight thereof, 35 to 60 wt %, and preferably 40 to 55 wt %, surfactant.

The group of surfactants includes the non-ionic, anionic, cationic and amphoteric surfactants. The compositions according to the invention can comprise one or more of the surfactants mentioned. Particularly preferred compositions contain surfactant from the group of anionic and non-ionic surfactants.

The anionic surfactant is preferably selected from the group comprising C₉-C₁₃ alkylbenzene sulfonates, olefin sulfonates, C₁₂-C₁₈ alkane sulfonates, ester sulfonates, alk(en)yl sulfates, fatty alcohol ether sulfates and mixtures thereof. Compositions which comprise C₃-C₁₃ alkylbenzene sulfonates and fatty alcohol ether sulfates as the anionic surfactant have particularly good dispersing properties. In this case, preferably C₃-C₁₃ alkylbenzene sulfonates, olefin sulfonates, i.e. mixtures of alkene and hydroxyalkane sulfonates, and disulfonates, as obtained, for example, from C₁₂-C₁₈ monoolefins having a terminal or internal double bond by way of sulfonation with gaseous sulfur trioxide and subsequent alkaline or acid hydrolysis of the sulfonation products, are possible as surfactants of the sulfonate type. C₁₂-C₁₈ alkane sulfonates and the esters of α-sulfo fatty acids (ester sulfonates) are also suitable, for example the α-sulfonated methyl esters of hydrogenated coconut, palm kernel or tallow fatty acids.

Preferred detergent preparations contain, relative to the total weight thereof, 12 to 30 wt %, and preferably 18 to 26 wt %, anionic surfactant.

It is very particularly preferred for the composition to contain at least one anionic surfactant of formula (I),

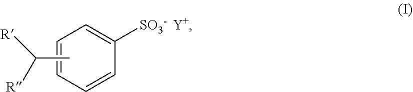

where
R′ and R″ are, independently of one another, H or alkyl, and together contain 8 to 18, preferably 9 to 15 and in particular 9 to 13, C atoms, and Y⁺ denotes a monovalent cation or the nth part of an n-valent cation (in particular monoethanolamine).

The group of the alkyl ether sulfates include the fatty alcohol ether sulfates, such as the sulfuric acid monoesters of straight-chain or branched C₇-C₂₁ alcohols ethoxylated with 1 to 6 mol ethylene oxide, such as 2-methyl-branched C9-11 alcohols having, on average, 3.5 mol ethylene oxide (EO) or C12-18 fatty alcohols having 1 to 4 EO. Alkyl ether sulfates of formula (II) are preferred

R¹—O—(AO)ₙ—SO₃—X⁺ (II)

In this formula (II), R 1 is a linear or branched, substituted or unsubstituted alkyl functional group, preferably a linear, unsubstituted alkyl functional group, particularly preferably a fatty alcohol functional group. Preferred R 1 functional groups of formula (II) are selected from decyl, undecyl, dodecyl, tridecyl, tetradecyl, pentadecyl, hexadecyl, heptadecyl, octadecyl, nonadecyl, eicosyl functional groups and the mixtures thereof, the representatives having an even number of C atoms being preferred. Particularly preferred functional groups R 1 of formula (II) are derived from fatty alcohols having 12 to 18 C atoms, for example from coconut fatty alcohol, tallow fatty alcohol, lauryl alcohol, myristyl alcohol, cetyl alcohol or stearyl alcohol, or from oxo alcohols having 10 to 20 C atoms.

AO in formula (II) represents an ethylene oxide (EO) or propylene oxide (PO) group, preferably an ethylene oxide group. The index n in formula (I) is an integer from 1 to 50, preferably from 1 to 20, and in particular from 2 to 10. Very particularly preferably, n is 2, 3, 4, 5, 6, 7 or 8. X is a monovalent cation or the nth part of an n-valent cation, the alkali metal ions, including Na⁺ or K⁺, being preferred in this case, with Na⁺ being most preferred. Further cations X⁺ may be selected from NH₄⁺, ½ An²⁺, ½ Mg²⁺, ½ Ca²⁺, ½ Mn²⁺ and the mixtures thereof, as well as primary and secondary amines, in particular monoethanolamine.

Particularly preferred compositions contain an alkyl ether sulfate selected from fatty alcohol ether sulfates of formula (III)

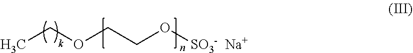

where k=11 to 19, and n=2, 3, 4, 5, 6, 7 or 8. Very particularly preferred representatives are Na fatty alcohol ether sulfates having 12 to 18 C atoms and 2 EO (k=11 to 13, n=2 in formula III). The degree of ethoxylation indicated represents a statistical average that can correspond to an integer or a fractional number for a specific product. The degrees of alkoxylation indicated represent statistical averages which can be an integer or a fractional number for a specific product. Preferred alkoxylates/ethoxylates have a narrowed homolog distribution (narrow range ethoxylates, NRE).

In summary, preferred detergent preparations contain, relative to the total weight thereof, 12 to 30 wt %, preferably 15 to 28 wt %, and in particular 18 to 26 wt %, anionic surfactant from the group of the C8-18 alkylbenzenesulfonates and alkyl ether sulfates—preferably from the group of the C8-18 alkylbenzenesulfonates.

The use of fatty acids has proven advantageous for stability and cleaning performance. Preferred detergent preparations therefore contain, relative to the total weight thereof, 4 to 12 wt %, and preferably 6 to 10 wt %, fatty acid. Particularly preferred fatty acids are selected from the group of caprylic acid, capric acid, lauric acid, myristic acid, palmitic acid, stearic acid, oleic acid, linoleic acid and mixtures thereof. In the context of the application, the fatty acids are not assigned to the group of anionic surfactants.

The detergent preparations contain non-ionic surfactant as a further preferred optional component. Their proportion by weight of the total weight of the detergent preparation is 12 to 30 wt. %, preferably 15 to 28 wt. %, and in particular 18 to 26 wt. %.

In particular the use of non-ionic surfactants from the group of alkyl ethoxylates is preferred, preferably alkyl ethoxylates from the group of the ethoxylated primary C8-18 alcohols, preferably the ethoxylated primary C₈₋₁₈ alcohols having a degree of alkoxylation≥4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO, being selected.

In summary, preferred detergent preparations contain non-ionic surfactants from the group of the ethoxylated primary C₈₋₁₈ alcohols, preferably the ethoxylated primary C₈₋₁₈ alcohols having a degree of alkoxylation 4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 E0.

With regard to the rheological properties of the detergent preparation, the processability and cleaning effect thereof, it has proven advantageous to use non-ionic surfactant and anionic surfactant in a weight ratio of from 2:1 to 1:2, preferably from 3:2 to 2:3.

As a further optional component, the detergent preparation contains a polyalkoxylated polyalkylene imine which is obtainable by reacting polyalkylene imines with alkylene oxides. On the basis of their cleaning performance, particularly preferred detergent preparations contain, relative to the total weight thereof, polyalkoxylated polyalkylene imine, which is obtainable by reacting polyalkylene imines with alkylene oxides in amounts of 0.5 to 7 wt %, preferably of 1.0 to 6 wt %, and in particular of 2.5 to 5 wt %.

The polyalkoxylated polyalkylene imine is a polymer having a polyalkylene imine backbone which carries polyalkoxy groups on the N atoms. It preferably has a weight-average molecular weight M_{w} in the range of 5,000 g/mol to 60,000 g/mol, and in particular 10,000 g/mol to 22,500 g/mol. The polyalkylene imine has primary amino functions at the ends and preferably both secondary and tertiary amino functions in the interior, and, optionally, it can also have only secondary amino functions in the interior, such that the result is not a branched-chain, but a linear polyalkylene imine. The ratio of primary to secondary amino groups in the polyalkylene imine is preferably in the range of 1:0.5 to 1:1.5, and in particular in the range of 1:0.7 to 1:1. The ratio of primary to tertiary amino groups in the polyalkylene imine is preferably in the range of 1:0.2 to 1:1, and in particular in the range of 1:0.5 to 1:0.8. The polyalkylene imine preferably has a weight-average molecular weight in the range of 500 g/mol to 50,000 g/mol, and in particular 550 g/mol to 2,000 g/mol. The N atoms in the polyalkylene imine are preferably separated from one another by alkylene groups having 2 to 12 C atoms, and in particular 2 to 6 C atoms, although it is not necessary for all the alkylene groups to have the same number of C atoms. Ethylene groups, 1,2-propylene groups, 1,3-propylene groups, and mixtures thereof are particularly preferred. The primary amino functions in the polyalkylene imine can carry 1 or 2 polyalkoxy groups, and the secondary amino functions can carry 1 polyalkoxy group, wherein not every amino function has to be alkoxy group-substituted. The average number of alkoxy groups per primary and secondary amino function in the polyalkoxylated polyalkylenimine is preferably 5 to 100, and in particular 10 to 50. The alkoxy groups in the polyalkoxylated polyalkylene imine are preferably ethoxy, propoxy, or butoxy groups, or mixtures thereof. Polyethoxylated polyethyleneimines are particularly preferred. The polyalkoxylated polyalkylene imines are obtainable by reacting the polyalkylene imines with epoxides corresponding to the alkoxy groups. If desired, the terminal OH function of at least some of the polyalkoxy substituents can be replaced by an alkyl ether function having 1 to 10, and in particular 1 to 3, C atoms.

Preferred detergent preparations contain, relative to the total weight thereof, 5 to 18 wt %, and preferably 7 to 15 wt %, water.

In addition to water, at least one organic solvent is preferably used as a further solvent. The use of aqueous-organic solvent systems has proven to be particularly advantageous for the producibility and storage life, and is therefore preferred.

In a preferred embodiment, the detergent preparation contains, relative to its total weight, 5 to 30 wt %, and preferably 10 to 20 wt %, organic solvent.

Preferred organic solvents are selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butyl ether, di-n-octyl ether, and mixtures thereof—preferably from the group of propanediol, glycerol, monoethanolamine, and mixtures thereof.

The detergent preparation contains a phosphonate as a preferred optional component.

The proportion by weight of phosphonate with respect to the total weight of the detergent preparation is preferably 0.1 to 3 wt. % and in particular 0.2 to 1 wt. %.

A phosphonate from the group of the hydroxyalkane phosphonates and/or aminoalkane phosphonates—preferably from the group of aminoalkane phosphonates, and in particular from the group of ethylenediamine tetramethylene phosphonate (EDTMP) and diethylenetriamine pentamethylene phosphonate (DTPMP), and in particular from the group diethylenetriamine pentamethylene phosphonate (DTPMP)—is preferably selected as the phosphonate compound.

The combination according to the invention of hexosaminidase preparation and polyalkoxylated amine is characterized by an unexpected washing effect on bleachable stains. Against this background, the addition of bleaching agents, and in particular oxygen bleaching agents, can be dispensed with in the detergent preparations. Preferred detergent preparations therefore contain less than 5 wt %, preferably less than 1 wt %, and in particular no bleaching agents—in particular, oxygen bleaching agents.

Bleaching agents are in particular understood to mean compounds that supply hydrogen peroxide in an aqueous medium. Among the compounds used as bleaching agents that supply H₂O₂ in water, sodium percarbonate, sodium perborate tetrahydrate, and sodium perborate monohydrate are of particular importance. Further bleaches that can be used are, for example, peroxopyrophosphates, citrate perhydrates, and H₂O₂—supplying peracidic salts or peracids such as persulfates or persulfuric acid. Also useful is urea peroxohydrate percarbamide, which can be described by the formula H₂N—CO—NH₂ H₂O₂. Particularly when the agents are used for cleaning hard surfaces, e.g., for automatic dishwashing, the detergent portion units can, if desired, also contain bleaching agents from the group of organic bleaching agents, although their use is in principle also possible in agents for washing fabrics. Typical organic bleaching agents are diacyl peroxides, such as, for example, dibenzoyl peroxide. Further typical organic bleaches are peroxy acids, wherein alkyl peroxy acids and arylperoxy acids are particularly mentioned as examples. Preferred representatives of this category are (a) peroxybenzoic acid and the ring-substituted derivatives thereof such as alkyl peroxy benzoic acids, but also peroxy-α-naphthoic acid and magnesium monoperphthalate, (b) aliphatic or substituted aliphatic peroxy acids, such as peroxylauric acid, peroxystearic acid, ε-phthalimidoperoxycaproic acid (phthaloiminoperoxyhexanoic acid (PAP)), o-carboxybenzamidoperoxycaproic acid, N-nonenylamidoperadipic acid, and N-nonenylamidopersuccinates, and (c) aliphatic and araliphatic peroxydicarboxylic acids, such as 1,12-diperoxycarboxylic acid, 1,9-dipiperoxyazelaic acid, diperoxysebacic acid, diperoxybrassylic acid, diperoxyphthalic acids, 2-decyldiperoxybutane-1,4-diacid, N,N-terephthaloyl-di(6-aminopercaproic acid). Preferred oxygen bleaching agents are formulated in particulate form, wherein the particles have a coating.

As a further optional component, a preferred detergent preparation comprises 0.2 to 4 wt %, and preferably 0.5 to 3 wt %, fragrance preparation.

In addition to the actual fragrances, the fragrance preparation comprises solvents, solid carrier materials or stabilizers, for example.

A fragrance is a chemical substance that stimulates the sense of smell. In order to be able to stimulate the sense of smell, the chemical substance should be able to be distributed in the air, at least in part, i.e., the fragrance should be volatile at 25° C., at least to a small degree. If the fragrance is very volatile, the odor intensity then decreases rapidly again. In the case of a lower volatility, however, the odor impression is more sustainable, i.e., it does not disappear as quickly. In one embodiment, the fragrance therefore has a melting point which is in the range from −100° C. to 100° C., preferably from −80° C. to 80° C., more preferably from −20° C. to 50° C., in particular from −30° C. to 20° C. In a further embodiment, the fragrance has a boiling point in the range from 25° C. to 400° C., preferably from 50° C. to 380° C., more preferably from 75° C. to 350° C., in particular from 100° C. to 330° C.

Overall, a chemical substance should not exceed a particular molecular mass in order to act as a fragrance, since the required volatility can no longer be ensured at too high a molecular mass. In one embodiment, the fragrance has a molecular mass of 40 to 700 g/mol, more preferably of 60 to 400 g/mol.

The odor of a fragrance is perceived as pleasant by most people, and frequently corresponds to the odor of, for example, flowers, fruits, spices, bark, resin, leaves, grasses, mosses and roots. Thus, fragrances can also be used to mask unpleasant odors or else to provide a non-smelling substance with a desired odor. Individual fragrance compounds, for example the synthetic products of the ester, ether, aldehyde, ketone, alcohol and hydrocarbon types, can be used as fragrances.

Preferably, mixtures of different fragrances are used, which together produce an attractive fragrance note. Such a mixture of fragrances can also be referred to as perfume or perfume oil. Perfume oils of this kind can also contain natural fragrance mixtures, as are obtainable from plant sources.

For the lengthening of the fragrance effect, it has proven advantageous to encapsulate the fragrance. In a corresponding embodiment, at least a portion of the fragrance is used in encapsulated form (fragrance capsules), in particular in microcapsules. However, the entire fragrance can also be used in encapsulated form. The microcapsules may be water-soluble and/or water-insoluble microcapsules. For example, melamine-urea-formaldehyde microcapsules, melamine-formaldehyde microcapsules, urea-formaldehyde microcapsules or starch microcapsules can be used. “Fragrance precursor” refers to compounds which release the actual fragrance only after chemical conversion/cleavage, typically by the action of light or other ambient conditions, such as pH, temperature, etc. Such compounds are often also referred to as “pro-fragrances”.

The composition of some preferred detergent preparations can be found in the following tables (information in wt % relative to the total weight of the preparation, unless otherwise indicated). The detergent preparations are preferably flowable under standard conditions (20° C., 1,013 mbar) and are particularly preferably packaged as detergent portion units in which the detergent preparation is completely enclosed by a water-soluble film.

| | Formula 1 | Formula 2 | Formula 3 | Formula 4 |
|---|---|---|---|---|
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Surfactant | 35 to 55 | 35 to 55 | 40 to 50 | 40 to 50 |
| Misc. | up to 100 | up to 100 | up to 100 | up to 100 |
| | Formula 6 | Formula 7 | Formula 8 | Formula 9 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Surfactant | 35 to 55 | 35 to 55 | 40 to 50 | 40 to 50 |
| Water | 5 to 18 | 5 to 18 | 7 to 15 | 7 to 15 |
| Misc. | up to 100 | up to 100 | up to 100 | up to 100 |
| | Formula 11 | Formula 12 | Formula 13 | Formula 14 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Surfactant | 35 to 55 | 35 to 55 | 40 to 50 | 40 to 50 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 16 | Formula 17 | Formula 18 | Formula 19 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Surfactant | 35 to 55 | 35 to 55 | 40 to 50 | 40 to 50 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 21 | Formula 22 | Formula 23 | Formula 24 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Surfactant | 35 to 55 | 35 to 55 | 40 to 50 | 40 to 50 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Phosphonate | 0.1 to 3 | 0.1 to 3 | 0.1 to 3 | 0.2 to 1 |
| Water | 5 to 18 | 5 to 18 | 7 to 15 | 7 to 15 |
| Misc. | up to 100 | up to 100 | up to 100 | up to 100 |
| | Formula 26 | Formula 27 | Formula 28 | Formula 29 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Misc. | up to 100 | up to 100 | up to 100 | up to 100 |
| | Formula 31 | Formula 32 | Formula 33 | Formula 34 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Water | 5 to 18 | 5 to 18 | 7 to 15 | 7 to 15 |
| Misc. | up to 100 | up to 100 | up to 100 | up to 100 |
| | Formula 36 | Formula 37 | Formula 38 | Formula 39 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 41 | Formula 42 | Formula 43 | Formula 44 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 46 | Formula 47 | Formula 48 | Formula 49 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Phosphonate | 0.1 to 3 | 0.1 to 3 | 0.1 to 3 | 0.2 to 1 |
| Water | 5 to 18 | 5 to 18 | 7 to 15 | 7 to 15 |
| Misc. | up to 100 | up to 100 | up to 100 | up to 100 |
| | Formula 51 | Formula 52 | Formula 53 | Formula 54 |
| Hexosaminidase preparation | 0.1 to 0.8 | 0.1 to 0.4 | 0.1 to 0.4 | 0.2 to 0.3 |
| polyalkoxylated amine ¹⁾ | 0.5 to 10 | 1 to 9 | 1 to 9 | 1.5 to 7.5 |
| Alkyl benzene sulfonic acid | 12 to 40 | 15 to 30 | 15 to 30 | 18 to 25 |
| Ethoxylated primary C₈₋₁₈ alcohols | 12 to 40 | 15 to 30 | 15 to 30 | 18 to 25 |
| having a degree of alkoxylation ≥4 | | | | |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Phosphonate | 0.1 to 3 | 0.1 to 3 | 0.1 to 3 | 0.2 to 1 |
| Water | 5 to 18 | 5 to 18 | 7 to 15 | 7 to 15 |
| Misc. | up to 100 | up to 100 | up to 100 | up to 100 |
| | Formula 55 | Formula 56 | Formula 57 | Formula 58 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Surfactant | 35 to 55 | 35 to 55 | 40 to 50 | 40 to 50 |
| Misc. | up to 100 | up to 100 | up to 100 | up to 100 |
| | Formula 61 | Formula 63 | Formula 64 | Formula 65 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Surfactant | 35 to 55 | 35 to 55 | 40 to 50 | 40 to 50 |
| Water | 5 to 18 | 5 to 18 | 7 to 15 | 7 to 15 |
| Misc. | up to 100 | up to 100 | up to 100 | up to 100 |
| | Formula 66 | Formula 67 | Formula 68 | Formula 69 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Surfactant | 35 to 55 | 35 to 55 | 40 to 50 | 40 to 50 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 71 | Formula 72 | Formula 73 | Formula 74 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Surfactant | 35 to 55 | 35 to 55 | 40 to 50 | 40 to 50 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 76 | Formula 77 | Formula 78 | Formula 79 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Surfactant | 35 to 55 | 35 to 55 | 40 to 50 | 40 to 50 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Phosphonate | 0.1 to 3 | 0.1 to 3 | 0.1 to 3 | 0.2 to 1 |
| Water | 5 to 18 | 5 to 18 | 7 to 15 | 7 to 15 |
| Misc. | up to 100 | up to 100 | up to 100 | up to 100 |
| | Formula 81 | Formula 82 | Formula 83 | Formula 84 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Misc. | up to 100 | up to 100 | up to 100 | up to 100 |
| | Formula 86 | Formula 87 | Formula 88 | Formula 89 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Water | 5 to 18 | 5 to 18 | 7 to 15 | 7 to 15 |
| Misc. | up to 100 | up to 100 | up to 100 | up to 100 |
| | Formula 91 | Formula 92 | Formula 93 | Formula 94 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 96 | Formula 97 | Formula 98 | Formula 99 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Water | 5 to 18 | 5 to 18 | 7 to 15 | 7 to 15 |
| Misc. | up to 100 | up to 100 | up to 100 | up to 100 |
| | Formula 101 | Formula 102 | Formula 103 | Formula 104 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Phosphonate | 0.1 to 3 | 0.1 to 3 | 0.1 to 3 | 0.2 to 1 |
| Water | 5 to 18 | 5 to 18 | 7 to 15 | 7 to 15 |
| Misc. | up to 100 | up to 100 | up to 100 | up to 100 |
| | Formula 106 | Formula 107 | Formula 108 | Formula 109 |
| Hexosaminidase preparation | 0.1 to 0.8 | 0.1 to 0.4 | 0.1 to 0.4 | 0.2 to 0.3 |
| polyalkoxylated amine ³⁾ | 0.5 to 10 | 1 to 9 | 1 to 9 | 1.5 to 7.5 |
| Alkyl benzene sulfonic acid | 12 to 40 | 15 to 30 | 15 to 30 | 18 to 25 |
| Ethoxylated primary C₈₋₁₈ | 12 to 40 | 15 to 30 | 15 to 30 | 18 to 25 |
| alcohols having a degree of | | | | |
| alkoxylation ≥4 | | | | |
| Fatty acid | 4 to 12 | 4 to 12 | 4 to 12 | 6 to 10 |
| Enzyme preparation ²⁾ | 0.2 to 5 | 0.2 to 5 | 0.2 to 5 | 0.5 to 4 |
| Phosphonate | 0.1 to 3 | 0.1 to 3 | 0.1 to 3 | 0.2 to 1 |
| Water | 5 to 18 | 5 to 18 | 7 to 15 | 7 to 15 |
| Misc. | up to 100 | up to 100 | up to 100 | up to 100 |

¹⁾ polyalkoxylated amine having a weight-average molecular weight M_{w} in the range of 600 g/mol to 10,000 g/mol, which is obtainable by reacting ammonia or primary alkyl or hydroxyalkylamines having a molecular weight of less than 200 g/mol with alkylene oxides
²⁾ at least one enzyme preparation, and preferably at least 3 enzyme preparations of enzymes from the group of lipase, amylase, protease, cellulase, preparations of a pectinolytic enzyme, and endoglucanase.
³⁾ polyalkoxylated amine having a weight-average molecular weight M_{w} in the range of 1,400 g/mol to 4,500 g/mol, which is obtainable by reacting ammonia or primary alkyl or hydroxyalkylamines having a molecular weight of less than 200 g/mol with alkylene oxides, the polyalkoxylated amines satisfying the general formula (I),

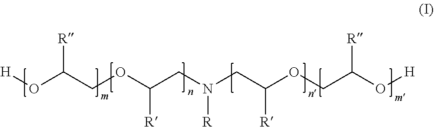

in which R represents a linear, optionally branched or optionally cyclic alkyl group having
1 to 12 C atoms or a —(CH₂CHR′O)ₙ—(CH₂CHR″O)ₘ—H group,
R′ and R″, independently of one another, represent H, CH₃ or CH₂CH₃,
n, n′, and n″, independently of one another, represent numbers from 0 to 30, preferably from 0 to 10, and in particular 0 to 5, and
m, m′, and m″, independently of one another, represent numbers from 0 to 30, preferably from 5 to 20, and in particular from 12 to 16,
with the proviso that the sum n+n′+n″+m+m′+m″ is at least 14, preferably in the range of from 18 to 100 and in particular in the range of from 20 to 70. Preferably, in the compounds of the formula I, at least one of the functional groups R′ and R″ is a CH₃ group.

The previously described material systems are not only suitable for ensuring simple producibility, a good storage life, and cleaning performance, but also enable the realization of product optics which are attractive to the consumer. For example, detergent preparations which are transparent and consequently have low turbidity are perceived as optically attractive. Preferred detergent preparations therefore have a turbidity (HACH Turbidimeter 2100Q, 20° C., 10 ml cuvette) below 100 NTU, preferably below 50 NTU, and in particular below 20 NTU. In the case of an NTU value (at 20° C.) of 60 or more, molded bodies exhibit a perceptible turbidity, within the meaning of the invention, identifiable by the naked eye.

The optical advantages of the concentrated detergent preparations come to bear in particular in packaging, which is in turn transparent and enables a direct view of the detergent composition. In addition to transparent plastic bottles, transparent bags, in particular water-soluble transparent bags, are therefore preferred for manufacturing and packaging.

A further preferred subject of this application is therefore a detergent portion unit comprising
i) a detergent preparation according to the invention
ii) a water-soluble film which completely surrounds the detergent preparation.

The water-soluble film in which the detergent preparation is packaged can comprise one or more structurally different water-soluble polymer(s). Suitable water-soluble polymer(s) are in particular polymers from the group of (optionally acetalized) polyvinyl alcohols (PVAL) and copolymers thereof.

Water-soluble films are preferably based on a polyvinyl alcohol or a polyvinyl alcohol copolymer of which the molecular weight is in the range of from 10,000 to 1,000,000 gmol⁻¹, preferably from 20,000 to 500,000 gmol⁻¹, particularly preferably from 30,000 to 100,000 gmol⁻¹, and in particular from 40,000 to 80,000 gmol⁻¹.

The production of the polyvinyl alcohol and polyvinyl alcohol copolymers generally includes the hydrolysis of intermediate polyvinyl acetate. Preferred polyvinyl alcohols and polyvinyl alcohol copolymers have a degree of hydrolysis of 70 to 100 mol. %, preferably 80 to 90 mol. %, particularly preferably 81 to 89 mol. %, and in particular 82 to 88 mol. %.

Polyvinyl alcohol copolymers which include, in addition to vinyl alcohol, an ethylenically unsaturated carboxylic acid, or the salt or ester thereof, are preferred. Polyvinyl alcohol copolymers of this kind particularly preferably contain, in addition to vinyl alcohol, sulfonic acids, such as 2-acrylamido-2-methyl-1-propane sulfonic acid (AMPS), acrylic acid, methacrylic acid, acrylic acid ester, methacrylic acid ester, or mixtures thereof; of the esters, C₁₋₄ alkyl esters or C₁₋₄ hydroxyalkyl esters are preferred. Ethylenically unsaturated dicarboxylic acids, for example itaconic acid, maleic acid, fumaric acid and mixtures thereof, are possible as further monomers.

Suitable water-soluble films for use are marketed, inter alia, by the company MonoSol LLC, for example under the name M8630, M8720, M8310, C8400 or M8900. For example, films with the name Solublon® PT, Solublon® GA, Solublon® KC or Solublon® KL by Aicello Chemical Europe GmbH or the VF-HP films by Kuraray are also suitable.

The water-soluble films can contain additional active ingredients or fillers, but also plasticizers and/or solvents, in particular water, as further ingredients.

In this case, the group of the further active ingredients includes, for example, materials which protect the ingredients of the preparation, which are surrounded by the film material, from decomposition or deactivation by light irradiation. Antioxidants, UV absorbers, and fluorescent dyes have proven to be particularly suitable here.

As plasticizers, it is possible to use, for example, glycerol, ethylene glycol, diethylene glycol, propanediol, 2-methyl-1,3-propanediol, sorbitol or mixtures thereof.

To reduce the coefficients of friction thereof, the surface of the water-soluble film of the detergent portion unit can optionally be powder-coated with fine powder. Sodium aluminosilicate, silicon dioxide, talc and amylose are examples of suitable powdering agents.

Preferred water-soluble films are suitable for processing in a deep-drawing apparatus.

The volume of the detergent portion unit is preferably from 12 to 22 mL, and in particular 12 to 20 mL.

Preferred detergent portion units have one to four receiving chambers, preferably three or four receiving chambers. In the case of detergent portion units having two or more receiving chambers, preferably at least one of the receiving chambers, preferably the majority of the receiving chambers, is transparent.

A further subject of the application is a method for cleaning textiles, in which a previously described detergent preparation or detergent portion unit is introduced into the washing liquor of a textile washing machine.

In preferred method variants, the detergent preparation or the detergent portion unit is metered directly into the drum or into the detergent drawer of the textile washing machine.

The textile washing process in a machine preferably takes place at temperatures of 20° C. to 60° C., and preferably of 30° C. to 45° C. Preferred textile washing processes are used to clean cotton fabric.

As stated at the outset, the detergent preparations described are particularly suitable for removing bleachable stains. The use of the detergent preparations or detergent portion unit described above for cleaning bleachable stains is therefore a further subject matter of the present application.

This application provides, inter alia, the following subject matter:
1. A detergent preparation containing, relative to the total weight thereof,
   a) hexosaminidase preparation;
   b) 0.5 to 10 wt % of a polyalkoxylated amine having a weight-average molecular weight M_{w} in the range of 600 g/mol to 10,000 g/mol, which is obtainable by reacting ammonia or primary alkyl or hydroxyalkylamines having a molecular weight of less than 200 g/mol with alkylene oxides.
2. The detergent preparation according to point 1, wherein the detergent preparation is liquid under standard conditions (20° C., 1,013 mbar).
3. The detergent preparation according to one of the preceding points, wherein the detergent preparation contains, relative to the total weight thereof, 0.01 to 5 wt %, preferably 0.1 to 4 wt %, and in particular 0.15 to 2.5 wt %, hexosaminidase preparation.
4. The detergent preparation according to one of the preceding points, wherein the hexosaminidase is selected from the group of β-hexosaminidases.
5. The detergent preparation according to one of the preceding points, wherein the detergent preparation contains, relative to the total weight thereof, 0.2 to 8 wt %, and preferably 0.5 to 6 wt %, enzyme preparation.
6. The detergent preparation according to one of the preceding points, wherein the detergent preparation also contains at least one enzyme preparation and preferably at least 3 enzyme preparations of enzymes from the group of lipase, amylase, protease, cellulase, preparations of a pectinolytic enzyme, and endoglucanase.
7. The detergent preparation according to one of the preceding points, wherein the detergent preparation contains, relative to the total weight thereof, 0.1 to 2 wt %, and preferably 0.2 to 1 wt %, of an amylase preparation.
8. The detergent preparation according to one of the preceding points, wherein the detergent preparation contains, relative to the total weight thereof, 0.2 to 3 wt %, and preferably 0.4 to 2 wt %, of a protease preparation.
9. The detergent preparation according to one of the preceding points, wherein the detergent preparation contains, relative to the total weight thereof, 0.01 to 1 wt %, and preferably 0.02 to 0.3 wt %, of a mannanase preparation.
10. The detergent preparation according to one of the preceding points, wherein the detergent preparation contains, relative to the total weight thereof, 0.01 to 1 wt %, and preferably 0.05 to 0.3 wt %, of a cellulase preparation.
11. The detergent preparation according to one of the preceding points, wherein the enzyme preparations, relative to the total weight thereof, have a proportion by weight of active protein of 0.1 to 40 wt %, and preferably 0.2 to 30 wt %.
12. The detergent preparation according to one of the preceding points, wherein the detergent preparation contains, relative to the total weight thereof, 1 to 8 wt %, and preferably 3 to 6 wt %, polyalkoxylated amine.
13. The detergent preparation according to one of the preceding points, wherein the polyalkoxylated amine has a weight-average molecular weight M_{w} in the range of 1,300 g/mol to 6,000 g/mol, and in particular 1,400 g/mol to 4,500 g/mol.
14. The detergent preparation according to one of the preceding points, wherein the polyalkoxylated amine can be obtained by reacting triethanolamine with alkene oxides.
15. The detergent preparation according to one of the preceding points, wherein the polyalkoxylated amine can be obtained by reacting ammonia or primary alkyl or hydroxyalkylamines with an alkene oxide from the group of ethylene oxide, propylene oxide, and mixtures thereof.
16. The detergent preparation according to one of the preceding points, wherein the detergent preparation contains, relative to the total weight thereof, 35 to 60 wt %, and preferably 40 to 55 wt %, surfactant.
17. The detergent preparation according to one of the preceding points, wherein the detergent preparation contains, relative to the total weight thereof, 12 to 30 wt %, and preferably 18 to 26 wt %, anionic surfactant.
18. The detergent preparation according to one of the preceding points, wherein detergent preparation contains, relative to the total weight thereof, 12 to 30 wt %, preferably 15 to 28 wt %, and in particular 18 to 26 wt %, anionic surfactant from the group of the C₈₋₁₈ alkylbenzenesulfonates and alkyl ether sulfates—preferably from the group of the C₈₋₁₈ alkylbenzenesulfonates.
19. The detergent preparation according to one of the preceding points, wherein the detergent preparation contains, relative to the total weight thereof, 12 to 30 wt %, and preferably 18 to 26 wt %, non-ionic surfactant.
20. The detergent preparation according to one of the preceding points, wherein the detergent preparation, relative to the total weight thereof, contains 12 to 30 wt %, preferably 15 to 28 wt %, and in particular 18 to 26, non-ionic surfactant from the group of the ethoxylated primary C₈₋₁₈ alcohols, preferably the ethoxylated primary C₈₋₁₈ alcohols having a degree of alkoxylation 4, particularly preferably the C₁₂₋₁₄ alcohols having 4 EO or 7 EO, the C₉₋₁₁ alcohols having 7 EO, the C₁₃₋₁₅ alcohols having 5 EO, 7 EO, or 8 EO, the C₁₃₋₁₅ oxo alcohols having 7 EO, the C₁₂₋₁₈ alcohols having 5 EO or 7 EO, and in particular the C₁₂₋₁₈ fatty alcohols having 7 EO or the C₁₃₋₁₅ oxo alcohols having 7 EO.
21. The detergent preparation according to one of the preceding points, wherein the detergent preparation contains non-ionic surfactant and anionic surfactant in a weight ratio of 3:1 to 1:2, preferably 2:1 to 1:2, and in particular 3:2 to 2:3.
22. The detergent preparation according to one of the preceding points, wherein the detergent preparation contains, relative to the total weight thereof, 4 to 12 wt %, and preferably 6 to 10 wt %, fatty acid.
23. The detergent preparation according to point 22, wherein the fatty acid is selected from the group of caprylic acid, capric acid, lauric acid, myristic acid, palmitic acid, stearic acid, oleic acid, linoleic acid, and mixtures thereof.
24. The detergent preparation according to one of the preceding points, wherein the detergent preparation contains, relative to the total weight thereof, 5 to 18 wt %, and preferably 7 to 15 wt %, water.
25. The detergent preparation according to one of the preceding points, wherein the detergent preparation contains, relative to the total weight thereof, 5 to 30 wt %, and preferably 10 to 20 wt %, organic solvent.
26. The detergent preparation according to point 25, wherein the organic solvent is selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether, di-n-octyl ether, and mixtures thereof, and preferably from the group of propanediol, glycerol, monoethanolamine, and mixtures thereof.
27. The detergent preparation according to one of the preceding points, wherein the detergent preparation contains, relative to the total weight thereof, 0.1 to 3 wt %, and preferably 0.2 to 1 wt %, phosphonate.
28. The detergent preparation according to one of the preceding points, wherein the detergent preparation contains phosphonate, and the phosphonate is selected from the group of hydroxyalkane phosphonates and/or aminoalkane phosphonates, preferably from the group of aminoalkane phosphonates, and in particular from the group of ethylenediamine tetramethylene phosphonate (EDTMP) and diethylenetriamine pentamethylene phosphonate (DTPMP).
29. The detergent preparation according to one of the preceding points, wherein the detergent preparation contains, relative to the total weight thereof, 0.2 to 4 wt %, and preferably 0.5 to 3 wt %, fragrance preparation.
30. A detergent portion unit comprising
   i) a detergent preparation according to one of points 1 through 29
   ii) a water-soluble film which completely surrounds the detergent preparation.
31. The detergent portion unit according to point 30, wherein the detergent portion unit has a volume of 12 to 22 mL, and preferably 12 to 20 mL.
32. The detergent portion unit according to one of points 30 or 31, wherein the detergent portion unit has one to four receiving chambers, and preferably three or four receiving chambers.
33. A method for textile cleaning, in which a detergent preparation according to one of points 1 through 29 or a detergent portion unit according to one of points 30 through 32 is introduced into the washing liquor of a textile washing machine.
34. The method according to point 33 for cleaning cotton fabric.
35. A use of the detergent preparation according to one of points 1 through 29 or of a detergent portion unit according to one of points 30 through 32 for cleaning bleachable soiling.

### Examples

Textile fabrics were provided with standardized impurities and subsequently washed at 40° C. in washing liquors which contained 1 g/l of a detergent V1 to V3 or E1. After washing, the textiles were dried. The brightness values of the cleaned textiles were determined. The stated values were obtained as mean values from five washing experiments.

TABLE 1
Detergent compositions (wt %)

| | V1 | V2 | V3 | E1 |
|---|---|---|---|---|
| 1,2-propanediol | 6.4 | 6.4 | 6.4 | 16.4 |
| Glycerol | 9.4 | 9.4 | 9.4 | 9.4 |
| Monoethanolamine | 6.0 | 6.0 | 6.0 | 6.0 |
| C12-18 fatty alcohol | 20 | 20 | 24.5 | 20 |
| ethoxylate, 7 EO | | | | |
| C10-13 alkylbenzene | 22 | 22 | 22 | 22 |
| sulfonic acid | | | | |
| C12-18 fatty acid | 7.0 | 7.0 | 7.0 | 7.0 |
| Ethoxylated polyethyl- | 4.5 | 4.5 | 4.5 | 4.5 |
| eneimine | | | | |
| DTPMP (40% in water) | 0.5 | 0.5 | 0.5 | 0.5 |
| Optical brightener | 0.5 | 0.5 | 0.5 | 0.5 |
| Protease | 2.6 | 2.6 | 2.6 | 2.6 |
| Mannanase | 0.1 | 0.2 | 0.2 | 0.2 |
| Amylase | 0.4 | 0.4 | 0.4 | 0.4 |
| Cellulase | 0.1 | 0.2 | 0.2 | 0.2 |
| β-hexosaminidase | — | 0.47 | 0.47 | 0.47 |
| polyalkoxylated | 4.5 | — | — | 4.5 |
| alkanolamine | | | | |
| Water, Misc | up to 100 | up to 100 | up to 100 | up to 100 |

The measurement results are shown in the following table (higher numbers show a higher degree of whiteness):

TABLE 2
Test results

| Spot | Textile | V1 | V2 | V3 | E1 |
|---|---|---|---|---|---|
| red wine | Cotton | 80.3 | 80.4 | 79.6 | 80.8 |
| Grass | Cotton | 57.0 | 56.8 | 56.6 | 57.6 |
| Tomato puree | Cotton | 78.9 | 77.8 | 78.2 | 79.4 |

What is claimed is:

1. A detergent preparation comprising, relative to the total weight thereof,
a) hexosaminidase preparation, and
b) 0.5 to 10 wt % of a polyalkoxylated amine having a weight-average molecular weight M_{w} in the range of 600 g/mol to 10,000 g/mol, which is obtainable by reacting ammonia or primary alkyl or hydroxyalkylamines having a molecular weight of less than 200 g/mol with alkylene oxides.

2. The detergent preparation according to claim 1, wherein the detergent preparation comprises, relative to the total weight thereof, 0.01 to 5 wt %, hexosaminidase preparation.

3. The detergent preparation according to claim 1, wherein the hexosaminidase is selected from the group consisting of β-hexosaminidases.

4. The detergent preparation according to claim 1, wherein the detergent preparation comprises, relative to the total weight thereof, 1 to 8 wt %, polyalkoxylated amine.

5. The detergent preparation according to claim 1, wherein the polyalkoxylated amine can be obtained by reacting triethanolamine with alkene oxides.

6. The detergent preparation according to claim 1, wherein the detergent preparation comprises, relative to the total weight thereof, 12 to 30 wt %, anionic surfactant.

7. The detergent preparation according to claim 1, wherein the detergent preparation comprises, relative to the total weight thereof, 12 to 30 wt %, non-ionic surfactant.

8. The detergent preparation according to claim 1, wherein the detergent preparation comprises non-ionic surfactant and anionic surfactant in a weight ratio of 3:1 to 1:2.

9. A detergent portion unit comprising
i) the detergent preparation according to claim 1, and
ii) a water-soluble film which completely surrounds the detergent preparation.

10. A method for cleaning textiles, in which the detergent portion unit according to claim 9 is introduced into the washing liquor of a textile washing machine.
